(19) United States
(12) Patent Application Publication
(10) Pub. No.: US 2017/0184950 A1
(43) Pub. Date: Jun. 29, 2017

(54) PROJECTION SYSTEM AND SCREEN THEREOF

(71) Applicant: Coretronic Corporation, Hsin-Chu (TW)

(72) Inventors: Yu-An Huang, Hsin-Chu (TW); Chi-Tang Hsieh, Hsin-Chu (TW); Chia-Hao Wang, Hsin-Chu (TW); Chien-Chiu Hsueh, Hsin-Chu (TW)

(73) Assignee: Coretronic Corporation, Hsin-Chu (TW)

(21) Appl. No.: 15/279,449

(22) Filed: Sep. 29, 2016

(30) Foreign Application Priority Data
Dec. 28, 2015 (TW) 104143971

(51) Int. Cl. G03B 21/20; G03B 21/62; G03B 21/56

(52) U.S. Cl. CPC G03B 21/204; G03B 21/567; G03B 21/62

(57) ABSTRACT

A projection system including a projection apparatus and a screen is provided. The projection apparatus is adapted to output a plurality of exciting beams respectively having a plurality of different wavebands. The screen is disposed on a transmission path of the exciting beams. The screen includes a plurality of fluorescence material layers and at least one gas barrier layer. The fluorescence material layers are adapted to be excited by the exciting beams to emit image beams respectively having different wavebands, so as to form an image frame. The gas barrier layer covers the fluorescence material layers.

### CROSS-REFERENCE TO RELATED APPLICATION

This application claims the priority benefit of Taiwan application serial no. 104143971, filed on Dec. 28, 2015. The entirety of the above-mentioned patent application is hereby incorporated by reference herein and made a part of this specification.

### BACKGROUND OF THE INVENTION

Field of the Invention

The invention relates to a projection system and a screen thereof, and particularly relates to an interactive projection system and a screen thereof which has a fluorescence layer.

Description of Related Art

In the current technology, the transparent display technology includes liquid crystal display (LCD) technology, organic light-emitting diode (OLED) display technology, hologram screen projection technology, and emission projection technology. The LCD technology and OLED display technology are currently dominant but not yet widely adopted mainly for low light transmittance, poor color, and limited size. The hologram screen projection technology is advantageous in large size but has a very small viewing angle. The emission projection technology faces a bottleneck in research and development of the fluorescence material.

The information disclosed in this “Description of Related Art” section is only for enhancement of understanding of the background of the invention and therefore it may contain information that does not form the prior art that is already known to a person of ordinary skill in the art. Furthermore, the information disclosed in this “Description of Related Art” section does not mean that one or more problems to be resolved by one or more embodiments of the invention were acknowledged by a person of ordinary skill in the art.

### SUMMARY OF THE INVENTION

The invention is directed to a projection system and a screen thereof, which achieve high transmittance as well as render favorable image quality. Moreover, the projection system and the screen thereof according to the invention are advantageous in large size production and have an increased viewing angle, and may be equipped with a touch panel for interaction with the user.

Other objects and advantages of the invention can be further illustrated by the technical features broadly embodied and described as follows.

In order to achieve one or a portion of or all of the objects or other objects, an embodiment of the invention provides a projection system that includes a projection apparatus and a screen. The projection apparatus is adapted to emit a plurality of exciting beams respectively having a plurality of different wavebands. The screen is disposed on a transmission path of the exciting beams. The screen includes a plurality of fluorescence material layers and at least one gas barrier layer. The fluorescence material layers are adapted to be excited by the exciting beams to emit a plurality of image beams respectively having different wavebands, so as to form an image frame. The gas barrier layer covers the fluorescence material layers.

In order to achieve one or a portion of or all of the objects or other objects, another embodiment of the invention provides a screen that includes a plurality of fluorescence material layers and at least one gas barrier layer. The fluorescence material layers are adapted to be excited by a plurality of exciting beams respectively having a plurality of different wavebands to emit a plurality of image beams respectively having different wavebands, so as to form an image frame. The gas barrier layer covers the fluorescence material layers.

According to the above descriptions, the embodiment of the invention has at least one of the following advantages or effects. In the embodiments of the invention, the fluorescence material layers of the screen are excited by the exciting beams, which are emitted by the projection apparatus and have a plurality of different wavebands, to emit a plurality of image beams having different wavebands, so as to form the image frame. Thereby, the projection system renders favorable display quality.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic view showing the projection system according to an embodiment of the invention.

FIG. 2 is a schematic view showing the fluorescence layers being excited according to an embodiment of the invention.

FIG. 3 is a schematic view showing the exciting beams and excited beams according to an embodiment of the invention.

FIG. 4 is a schematic view showing a layered structure of the screen according to an embodiment of the invention.

FIG. 5 is a schematic view showing the fluorescence layer structure according to an embodiment of the invention.

FIG. 6 is a schematic view showing the fluorescence layer structure according to another embodiment of the invention.

FIG. 7 is a schematic view showing the fluorescence layer structure according to another embodiment of the invention.

FIG. 8 is a schematic view showing the fluorescence material layer having a scattering particle distribution therein according to an embodiment of the invention.

FIG. 9 and FIG. 10 are schematic views respectively showing scattering particles of different sizes that perform Mie scattering on the incident beam according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

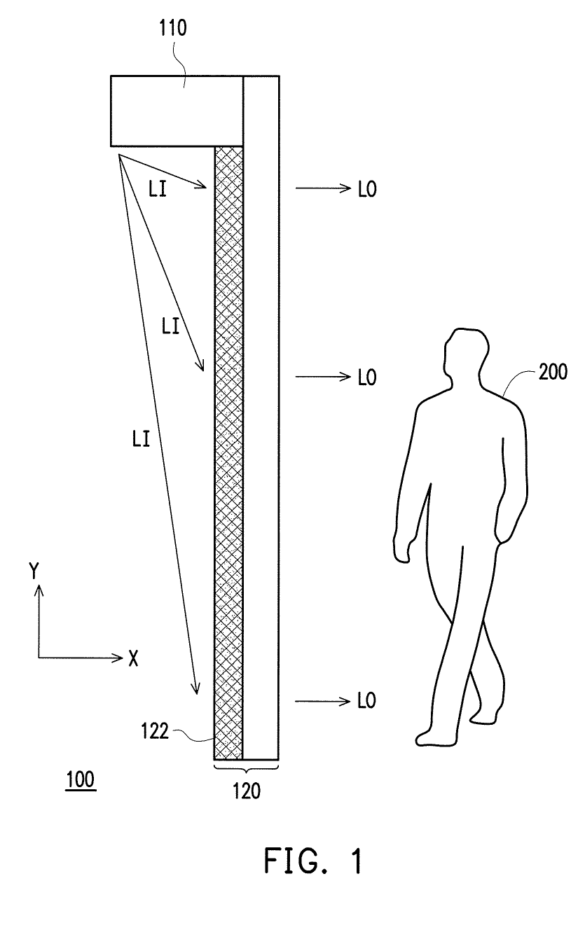

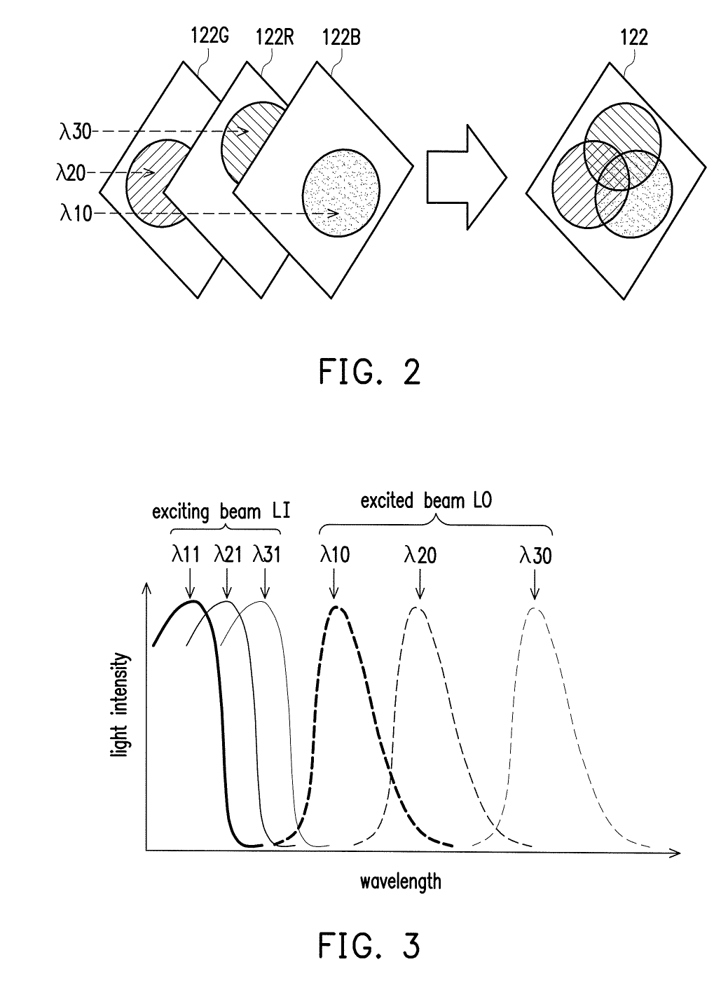

FIG. 1 is a schematic view showing a projection system according to an embodiment of the invention. FIG. 2 is a schematic view showing fluorescence layers being excited according to an embodiment of the invention. FIG. 3 is a schematic view showing exciting beams and excited beams according to an embodiment of the invention. Referring to FIG. 1 to FIG. 3, a projection system 100 of this embodiment includes a projection apparatus 110 and a screen 120. In this embodiment, the projection apparatus 110 is adapted to emit a plurality of exciting beams LI having different wavebands. The screen 120 is disposed on a transmission path of the exciting beams LI. The screen 120 includes a fluorescence layer 122. The fluorescence layer 122 is adapted to be excited by the exciting beams LI to emit a plurality of image beams LO having different wavebands, i.e. excited beams, so as to form an image frame to be projected to a viewer 200. In an embodiment, the screen 120 further includes a gas barrier layer (not shown, but will be described in detail later in this specification) to cover the fluorescence layer 122, so as to prevent deterioration of a fluorescence material in the fluorescence layer 122 caused by oxygen and moisture. In this embodiment, the exciting beams LI are emitted from a plurality of laser light sources having different light-emitting wavelengths in the projection apparatus 110, for example. The proportion of the sizes of the components shown in FIG. 1 is for illustrative purposes and the invention is not limited thereto. In addition, although FIG. 1 illustrates a rear projection system as an example in this embodiment, the invention is not limited thereto. In an embodiment, the screen 120 including the fluorescence layer 122 may also be applied to a front projection system.

Referring to FIG. 2, in this embodiment, the screen 120 is a transparent display screen having a touch function, for example, and the fluorescence layer 122 therein is colorless and transparent to allow the viewer 200 to interact with the projection system 100. In this embodiment, the projection apparatus 110 is an ultra-short focus ultraviolet laser projector, for example, adapted to project an ultraviolet laser to the screen 120 to excite the fluorescence layer 122, so as to generate the image beams and thereby display the image frame. Nevertheless, the invention is not limited thereto. In an embodiment, the projection apparatus 110 may also project an exciting beam having a visible waveband, e.g. a blue light beam, to excite the fluorescence layer 122, so as to display the image frame.

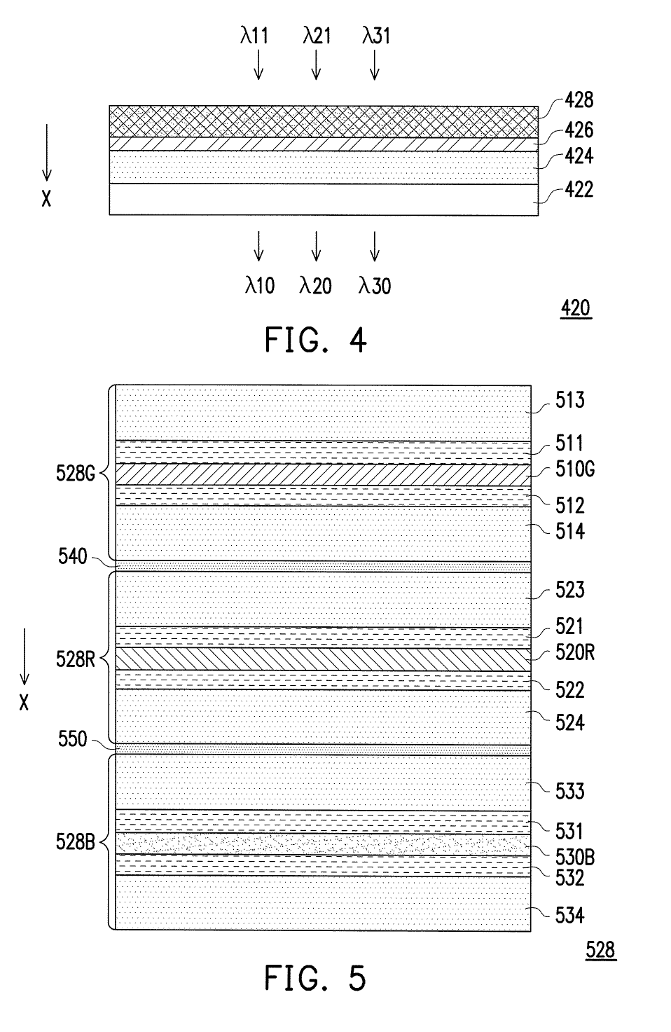

As shown in FIG. 2, FIG. 3, and FIG. 4, in this embodiment, the fluorescence layer 122 includes a fluorescence material layer 122G, a fluorescence material layer 122R, and a fluorescence material layer 122B, for example. The exciting beams LI have a plurality of different wavebands, i.e. λ11, λ21, and λ31. In this embodiment, the fluorescence material layer 122G, the fluorescence material layer 122R, and the fluorescence material layer 122B are colorless and transparent and may be excited by the exciting beams LI, i.e. the ultraviolet laser, to emit the excited beams having different wavebands, i.e. λ10, λ20, and λ30, to form the image beams LO. The excited beams are beams of various colors, such as green, red, and blue. In this embodiment, the colors of the excited beams as illustrated are merely examples, and the invention is not limited thereto. In an embodiment, the fluorescence material layer may also be excited by a blue laser, i.e. the exciting beam LI, to emit beams of various colors that have different wavebands. In this example, at least one of the fluorescence material layers is colorless and transparent.

Referring to FIG. 4 again, FIG. 4 is a schematic view showing a layered structure of the screen according to an embodiment of the invention. A screen 420 of this embodiment includes a fluorescence layer 428, an anti-light layer 426, a touch panel 424, and a glass substrate 422. The anti-light layer 426 is a film prepared against a specific wavelength, for example, which is disposed on a side of the fluorescence layer 428 that is away from the projection apparatus 110 for blocking light of the specific wavelength from transmitting to the human eyes. In this embodiment, the anti-light layer 426 is adapted to block the exciting beams LI of ultraviolet laser or blue laser, and allows the image beams LO generated by exciting the fluorescence layer 428 to pass, for example. For example, the anti-light layer 426 is an optical adhesive having anti-blue light properties or an ultraviolet resistant coating. When used for rear projection, in order to prevent the ultraviolet laser or blue laser from causing harm to the human eyes, the anti-light layer 426 may be disposed in the screen 420 for blocking the ultraviolet laser or blue laser. When used for front projection, since the fluorescence material absorbs the ultraviolet laser or blue laser, the anti-light layer 426 may be selectively disposed. Nevertheless, the invention is not limited thereto. In this embodiment, the touch panel 424 provides the screen 420 a touch function. The glass substrate 422 is for protecting the screen 420 to prevent the touch panel 424 or the fluorescence layer 428 from being damaged by an inappropriate force when the viewer 200 interacts with the screen 420. In this embodiment, the glass substrate 422 has a thickness of about 1.5 mm, for example. However, it should be noted that the thickness illustrated here is merely an example and the invention is not limited thereto.

FIG. 5 is a schematic view showing the fluorescence layer structure according to an embodiment of the invention. Referring to FIG. 5, a fluorescence layer 528 of this embodiment includes fluorescence material structure layers 528G, 528R, and 528B and optical adhesive layers 540 and 550. In this embodiment, after the fluorescence material structure layers 528G, 528R, and 528B are excited, excited beams having different wavebands, such as green, red, and blue beams, are generated respectively. The optical adhesive layers 540 and 550 are respectively disposed between the fluorescence material structure layers 528G and 528R and between the fluorescence material structure layers 528R and 528B to be bonded to the fluorescence material structure layers on two sides. In this embodiment, a material of the optical adhesive layers 540 and 550 includes an acrylic material or a silicone material, for example. A thickness thereof is in a range of 50 um to 100 um, for example. However, it should be noted that the material and thickness illustrated here are merely examples and the invention is not limited thereto.

In this embodiment, each of the fluorescence material structure layers includes a plurality of substrates, a plurality of gas barrier layers, and a fluorescence material layer. Each fluorescence material layer is interposed between two gas barrier layers. Each fluorescence material layer and the two gas barrier layers on two sides of the fluorescence material layer are interposed between two substrates. For example, the fluorescence material structure layer 528G includes substrates 513 and 514, gas barrier layers 511 and 512, and a fluorescence material layer 510G. The fluorescence material layer 510G is interposed between the two gas barrier layers 511 and 512. The fluorescence material layer 510G and the two gas barrier layers 511 and 512 on two sides of the fluorescence material layer 510G are interposed between the two substrates 513 and 514. In this embodiment, in order to prevent the fluorescence material layer 510G from being affected by oxygen and moisture, the two gas barrier layers 511 and 512 are disposed to keep out water vapor, but the invention is not limited thereto. A water vapor transmission rate (WVTR, index for testing the gas barrier layer) of the gas barrier layers 511 and 512 is smaller than or equal to 10⁻² g/m²/day to achieve the protection. Nevertheless, the invention is not limited thereto, and the water vapor transmission rate may be adjusted according to the actual design requirement. In this embodiment, a material of the substrates 513 and 514 includes polyethylene terephthalate (PET), for example. A thickness thereof is about 150 um, for example. However, it should be noted that the material and thickness illustrated here are merely examples and the invention is not limited thereto. In this embodiment, the barrier layers 511 and 512 may be a high barrier film, as the model name MS-F0025P or MS-F0050P of LINTEC Corporation, for example, the invention is not limited thereto.

The layered structures of the fluorescence material structure layers 528R and 528B of this embodiment may be formed accordingly and thus are not repeated hereinafter. In this embodiment, the fluorescence material layers 510G, 520R, and 530B are respectively excited to generate a green beam, a red beam, and a blue beam, for example.

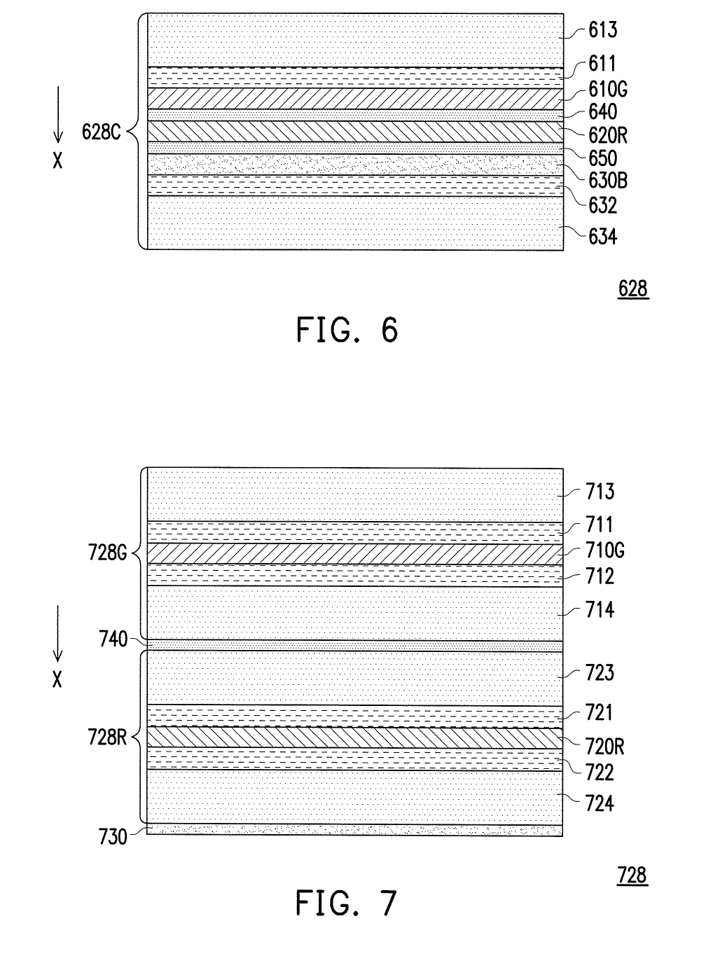

FIG. 6 is a schematic view showing the fluorescence layer structure according to another embodiment of the invention. Referring to FIG. 6, a fluorescence layer 628 of this embodiment includes a fluorescence material structure layer 628C. In this embodiment, the fluorescence material structure layer 628C includes two substrates 613 and 634, two gas barrier layers 611 and 632, a plurality of fluorescence material layers 610G, 620R, and 630B, and a plurality of isolation layers 640 and 650. The fluorescence material layers 610G, 620R, and 630B are interposed between the two gas barrier layers 611 and 632. The fluorescence material layers 610G, 620R, and 630B and the two gas barrier layers 611 and 632 on two sides thereof are interposed between the two substrates 613 and 634. The fluorescence material layers 610G, 620R, and 630B are excited by exciting beams to generate excited beams respectively having different wavebands, such as green, red, and blue beams. The isolation layers 640 and 650 are respectively disposed between the adjacent fluorescence material layers 610G and 620R and between the adjacent fluorescence material layers 620R and 630B. In this embodiment, the isolation layers 640 and 650 are transparent photoresist materials, for example, and are cured after being irradiated by light. Nevertheless, the invention is not limited thereto.

FIG. 7 is a schematic view showing the fluorescence layer structure according to another embodiment of the invention. Referring to FIG. 7, a fluorescence layer 728 of this embodiment includes fluorescence material structure layers 728G and 728R, an optical adhesive layer 740, and a scattering particle layer 730. In this embodiment, the fluorescence material structure layers 728G and 728R are excited by exciting beams to generate excited beams respectively having different wavebands, e.g. green and red beams. The optical adhesive layer 740 is disposed between the fluorescence material structure layers 728G and 728R to be bonded to the fluorescence material structure layers on two sides. In this embodiment, the scattering particle layer 730 is disposed on a side of the fluorescence material layers 710G and 720R in the fluorescence material structure layers 728G and 728R, which is away from the projection apparatus 110. In this embodiment, the projection apparatus 110 is further adapted to emit a visible exciting beam, e.g. blue laser. A portion of the visible exciting beam passes through the fluorescence material layers 710G and 720R and then is scattered by the scattering particle layer 730 to form a partial image beam to serve as a blue pixel component in the image frame.

The fluorescence material structure layers 728G and 728R and the optical adhesive layer 740 of this embodiment are similar to the fluorescence material structure layers 528G and 528R and the optical adhesive layer 540 of the embodiment of FIG. 5. Properties of these material films may be understood sufficiently from the teaching, suggestion, and illustration of the embodiment of FIG. 5 and thus are not repeated hereinafter.

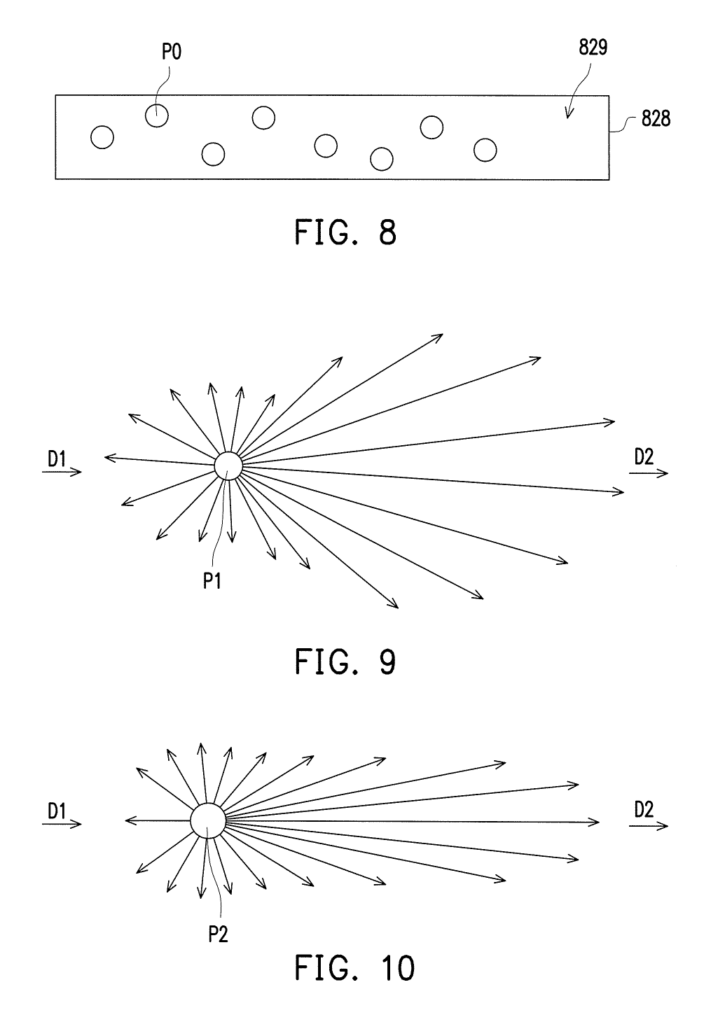

FIG. 8 is a schematic view showing a fluorescence material layer having a scattering particle distribution therein according to an embodiment of the invention. FIG. 9 and FIG. 10 are schematic views respectively showing scattering particles of different sizes that perform Mie scattering on the incident beam according to an embodiment of the invention. Referring to FIG. 8 to FIG. 10, a fluorescence material layer 828 of this embodiment includes a matrix 829, a fluorescence material, and a plurality of Mie scattering particles P0, for example. The fluorescence material has been mixed into the matrix 829 and therefore is not marked by any reference numeral. In this embodiment, the fluorescence material is dispersed in the matrix 829 that has a photoinitiator, for example. The fluorescence material layer 828 is produced by a roll to roll (R2R) method and is flexible for large area production. The fluorescence material, for example, is dispersed in the matrix 829 in a concentration of 1% to 10% by weight. A material of the matrix 829 may include epoxy, acrylate, or silicon. The concentration of the fluorescence material may be adjusted according to different matrices 829, so as to adjust the light emitting efficiency.

On average, the particle sizes of the particles of the fluorescence material are smaller than 1/10 of the waveband of the exciting beam. The exciting beam generates Rayleigh scattering after irradiating the fluorescence material particles and is uniformly scattered in all directions and causes the unidirectional light emitting efficiency to be insufficient. Therefore, in this embodiment, the Mie scattering particles P0 are doped into the matrix 829 and are uniformly distributed therein randomly and arbitrarily. In this embodiment, the particle size of the Mie scattering particles P0 is smaller than 5 um and greater than or equal to 0.5 um. The Mie scattering particles P0 are 1% to 5% by weight of the fluorescence layer 828. The fluorescence material layer 828 may be any one of the fluorescence material layers 510G, 520R, and 530B of FIG. 5, the fluorescence material layers 610G, 620R, and 630B of FIG. 6, and the fluorescence material layers 710G and 720R of FIG. 7.

As shown in FIG. 9 and FIG. 10, in this embodiment, the particle sizes of Mie scattering particles P1 and P2 are smaller than 5 um and greater than or equal to 0.5 um, and the refractive indexes thereof are smaller than the refractive index of the matrix 829. The particle size of the Mie scattering particle P2 is greater than the particle size of the Mie scattering particle P1. The Mie scattering particles P1 and P2 perform Mie scattering on the image beam that enters in an incident direction D1 and effectively scatter the excited beams out of the fluorescence material layer in an exit direction D2, as shown in FIG. 9 and FIG. 10, so as to improve the brightness of the image frame seen by the viewer 200.

In conclusion of the above, the embodiments of the invention achieve at least one of the following advantages or effects. In the embodiments of the invention, the projection apparatus utilizes the photoluminescence (PL) mechanism of the fluorescence layers of the screen to selectively output exciting beams having different exciting wavebands, so as to excite the fluorescence material layers to generate image beams of different colors for the screen to provide the colorful image frame. The projection apparatus provides a display signal and may be coordinated with the touch panel to form an interactive transparent projection system. The substrate of the screen is coated with the transparent fluorescence materials that can be excited to generate image beams of different colors. Therefore, in the embodiments of the invention, the fluorescence material layers of the screen are respectively excited by the exciting beams, which are emitted by the projection apparatus and have a plurality of different wavebands, to emit image beams having different wavebands, so as to form the image frame. Thereby, the projection system renders favorable display quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. These claims may refer to use “first”, “second”, etc. following with noun or element. Such terms should be understood as a nomenclature and should not be construed as giving the limitation on the number of the elements modified by such nomenclature unless specific number has been given. Moreover, no element and component in the present disclosure is intended to be dedicated to the public regardless of whether the element or component is explicitly recited in the following claims.

What is claimed is:

1. A projection system, comprising:
a projection apparatus adapted to emit a plurality of exciting beams respectively having a plurality of different wavebands; and
a screen disposed on a transmission path of the exciting beams, wherein the screen comprises:
a plurality of fluorescence material layers adapted to be excited by the exciting beams respectively to emit a plurality of image beams having different wavebands, so as to form an image frame; and
at least one gas barrier layer covering the fluorescence material layers.

2. The projection system according to claim 1, wherein at least one of the fluorescence material layers is colorless and transparent.

3. The projection system according to claim 1, wherein the screen further comprises an anti-specific wavelength film disposed on a side of the fluorescence material layers that is away from the projection apparatus for blocking a specific wavelength from being transmitted to a human eye.

4. The projection system according to claim 3, wherein the anti-specific wavelength film is adapted to block the exciting beams and allow the image beams having different wavebands that are generated by exciting the fluorescence material layers to pass through.

5. The projection system according to claim 1, wherein the screen further comprises a plurality of substrates, wherein the at least one gas barrier layer is a plurality of gas barrier layers, each of the fluorescence material layers is interposed between two of the gas barrier layers, and the each of the fluorescence material layers and the two of the gas barrier layers on two sides of the each of the fluorescence material layers are interposed between two of the substrates.

6. The projection system according to claim 1, wherein the screen further comprises two substrates, wherein the at least one gas barrier layer is two gas barrier layers, the fluorescence material layers are interposed between the two gas barrier layers, and the fluorescence material layers and the two gas barrier layers on two sides of the fluorescence material layers are interposed between the two substrates.

7. The projection system according to claim 6, wherein an isolation layer is disposed between adjacent two fluorescence material layers.

8. The projection system according to claim 1, wherein the screen further comprises a scattering particle layer disposed on a side of the fluorescence material layers that is away from the projection apparatus, and the projection apparatus is further adapted to emit a visible exciting beam that passes through the fluorescence material layers to be scattered by the scattering particle layer.

9. The projection system according to claim 1, wherein each of the fluorescence material layers comprises:
a matrix;
a fluorescence material mixed into the matrix; and
a plurality of Mie scattering particles doped into the matrix.

10. The projection system according to claim 9, wherein the Mie scattering particles have a particle size that is smaller than 5 um and greater than or equal to 0.5 um.

11. The projection system according to claim 1, wherein the exciting beams are emitted from a plurality of laser light sources having different emission wavelengths in the projection apparatus.

12. A screen, comprising:
a plurality of fluorescence material layers adapted to be excited by a plurality of exciting beams respectively having a plurality of different wavebands to emit a plurality of image beams having different wavebands, so as to form an image frame; and
at least one gas barrier layer covering the fluorescence material layers.

13. The screen according to claim 12, wherein at least one of the fluorescence material layers is colorless and transparent.

14. The screen according to claim 12, further comprising an anti-specific wavelength film disposed on a side of the fluorescence material layers and adapted to block a specific wavelength from being transmitted to a human eye.

15. The screen according to claim 14, wherein the anti-specific wavelength film is adapted to block the exciting beams and allow the image beams generated by exciting the fluorescence material layers to pass through.

16. The screen according to claim 12, further comprising a plurality of substrates, wherein the at least one gas barrier layer is a plurality of gas barrier layers, each of the fluorescence material layers is interposed between two of the gas barrier layers, and the each of the fluorescence material layers and the two of the gas barrier layers on two sides of the each of the fluorescence material layers are interposed between two of the substrates.

17. The screen according to claim 12, further comprising two substrates, wherein the at least one gas barrier layer is two gas barrier layers, the fluorescence material layers are interposed between the two gas barrier layers, and the fluorescence material layers and the two gas barrier layers on two sides of the fluorescence material layers are interposed between the two substrates.

18. The screen according to claim 17, wherein an isolation layer is disposed between adjacent two fluorescence material layers.

19. The screen according to claim 12, further comprising a scattering particle layer disposed on a side of the fluorescence material layers and adapted to scatter a visible light that passes through the fluorescence material layers.

20. The screen according to claim 12, wherein each of the fluorescence material layers comprises:
a matrix;
a fluorescence material mixed into the matrix; and
a plurality of Mie scattering particles doped into the matrix.
